(19) United States
(12) Patent Application Publication
(10) Pub. No.: US 2008/0141271 A1
(43) Pub. Date: Jun. 12, 2008

(54) METHOD AND SYSTEM FOR EXCHANGING DATA BETWEEN AN INPUT-OUTPUT MODULE AND A PROCESSING UNIT

(75) Inventors: Ben Zyon Gilboa, Or Yehuda (IL); Mordehay Cohen, Givatayim (IL); Avi Halfon, Ramat Gan (IL)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/567,261

(22) Filed: Dec. 6, 2006

(51) Int. Cl. G06F 3/00

(52) U.S. Cl. 719/313

(57) ABSTRACT

A method and system for managing exchange of data between at least one input-output (I/O) module and a processing unit is provided. The method at the at least one I/O module includes receiving (504) the data from at least one electronic equipment. The at least one electronic equipment is capable of collecting data. Further, the method includes exchanging (506) the data with the processing unit. The exchange of the data is governed by the at least one I/O module and the data is exchanged in a data messaging structure. The data messaging structure allows the exchange of one or more data type, which include at least one of an analog input data, an analog output data, a digital input data, a digital output data, configuration data, status data and command data.

The present invention generally relates to electronic control systems, and more particularly, to a method and system for exchanging data between an input-output module and a processing unit in an electronic control system.

### BACKGROUND OF THE INVENTION

Supervisory Control and Data Acquisition (SCADA) systems are used for controlling equipments and operations at remote locations. A SCADA system has electronic control systems, known as remote terminal units (RTUs), at each of the locations that are controlled remotely. An RTU is connected to several data acquisition devices through dedicated Input-Output (I/O) modules. The I/O modules exchange the data captured by the data acquisition devices such as sensors with a processing unit of the RTU and vice versa. The exchange of the data between the I/O modules and the processing unit is primarily governed by the processing unit.

To connect a new data acquisition device to the RTU, the corresponding I/O module is added. To identify the newly added I/O module, either the processing unit includes new hardware and software components corresponding to the newly added I/O module or the processing unit is modified corresponding to the I/O module. Development of the hardware and software components or modification of the processing unit can require a substantial amount of time. Consequently, the design cycle time for adding a new data acquisition device increases significantly. Moreover, the additional cost of software and hardware components for the processing unit increases the overall cost of adding a new data acquisition device.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an example of an electronic control system, where various embodiments of the present invention can be practiced;

FIG. 2 illustrates an example of an electronic control system, in accordance with an embodiment of the present invention;

FIG. 3 illustrates an example of an electronic control system, in accordance with another embodiment of the present invention;

FIG. 4 illustrates an example of a Remote Terminal Unit (RTU) associated with a SCADA system, in accordance with yet another embodiment of the present invention;

FIG. 5 is a flow diagram illustrating a method for managing exchange of data between at least one input-output (I/O) module and a processing unit, in accordance with an embodiment of the present invention; and

FIG. 6 is a flow diagram illustrating a method for managing exchange of data between at least one input-output (I/O) module and a processing unit, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help to improve an understanding of embodiments of the present invention.

### DETAILED DESCRIPTION

Before describing in detail the particular method and system for exchanging data between an input-output module and a processing unit, in accordance with various embodiments of the present invention, it should be observed that the present invention resides primarily in combinations of method steps related to managing the exchange of data between at least one input-output (I/O) module and a processing unit. Accordingly, the apparatus components and method steps have been represented, where appropriate, by conventional symbols in the drawings, showing only those specific details that are pertinent for an understanding of the present invention, so as not to obscure the disclosure with details that will be readily apparent to those of ordinary skill in the art, having the benefit of the description herein.

In this document, relational terms such as first and second, top and bottom, and the like may be used solely to distinguish one entity or action from another entity or action without necessarily requiring or implying any actual such relationship or order between such entities or actions.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

It will be appreciated that embodiments of the invention described herein may be comprised of one or more conventional processors and unique stored program instructions that control the one or more processors to implement, in conjunction with certain non-processor circuits, some, most, or all of the functions of exchanging data between an input-output module and a processing unit described herein. The non-processor circuits may include, but are not limited to, a radio receiver, a radio transmitter, signal drivers, clock circuits, power source circuits, and user input devices. As such, these functions may be interpreted as steps of a method to perform for exchanging data between an input-output module and a processing unit. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In an embodiment of the present invention, an electronic control system is provided. The electronic control system includes a processing unit to support a data messaging structure to exchange data in the electronic control system. Further, the electronic control system includes at least one input-output (I/O) module coupled to the processing unit. Further, the at least one I/O module includes a processor to govern the exchange of the data between the at least one I/O module and the processing unit. The data is exchanged in the data messaging structure. The data messaging structure provides for the exchange of one or more data type such as an analog input data, an analog output data, a digital input data, a digital output data, a configuration data, a status data and a command data. The at least one I/O module also includes a transaction module coupled to the processor to enable the exchange of the data between the at least one I/O module and the processing unit through a data train.

In an embodiment of the present invention, an electronic control system is provided. The electronic control system includes at least one input-output (I/O) module to govern exchange of data in the electronic control system. The electronic control system also includes a processing unit coupled to the at least one input-output module. Further, the processing unit includes a processor to recognize the at least one I/O module, based on a data messaging structure of a data train, received from the at least one I/O module. The data messaging structure allows the exchange of one or more data type, which includes an analog input data, an analog output data, a digital input data, a digital output data, configuration data, status data and command data. Furthermore, the processing unit also includes a communication module coupled to the processor to support the exchange of the data between the processing unit and the at least one I/O module.

In an embodiment of the present invention, a method for managing exchange of data between at least one input-output (I/O) module and a processing unit is provided. The method at the at least one I/O module includes receiving the data from at least one electronic equipment. The at least one electronic equipment collects one or more data. Further, the method includes exchanging the data with the processing unit. The exchange of the data is governed by the at least one I/O module and the data is exchanged in a data messaging structure. Further, the data messaging structure allows exchange of one or more data type, which includes an analog input data, an analog output data, a digital input data, a digital output data, configuration data, status data and command data.

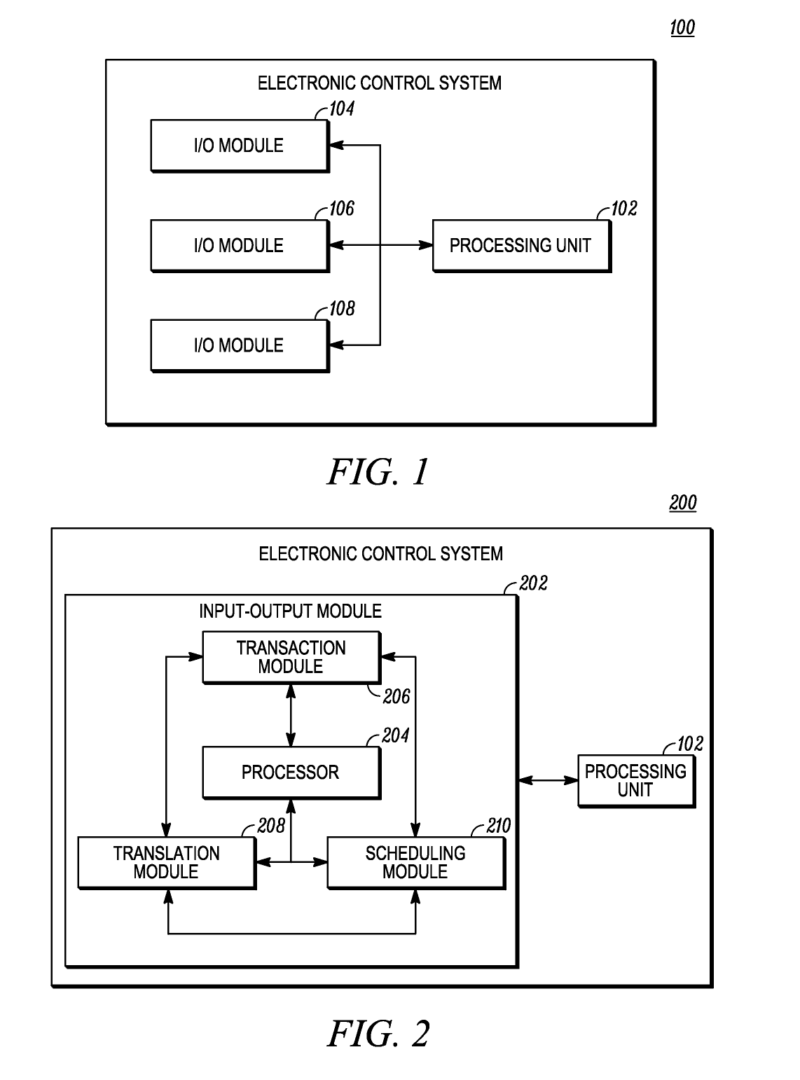

FIG. 1 illustrates an example of an electronic control system 100, where various embodiments of the present invention can be practiced. An example of the electronic control system 100 can be a remote terminal unit (RTU) associated with a supervisory control and data acquisition (SCADA) system. The electronic control system 100 includes a processing unit 102 and at least one input-output (I/O) module 104, 106 and 108. The at least one I/O module 104, 106 and 108 operates as an interface between the processing unit 102 and at least one electronic equipment such as a sensor (not shown in FIG. 1). Each I/O module, for example, the I/O module 104 can receive data from at least one electronic equipment and exchange the data with the processing unit 102. In an embodiment, an I/O module, for example, the I/O module 104, can be associated with only one electronic equipment, for example, a temperature sensor. In this embodiment, the I/O module 104 exchanges the data, which it receives from the electronic equipment, with the processing unit 102. For example, when the I/O module 104 is associated with the temperature sensor, it exchanges the data received from the temperature sensor with the processing unit 102.

Further, the processing unit 102 also operates to exchange data with the at least one I/O module, for example, the I/O module 104. In an embodiment, the processing unit 102 can also process the data, which it receives from the I/O module 104, and sends the processed data to a central server (not shown in the FIG. 1). The central server can monitor the electronic control system 100. For example, the electronic control system 100 can be an RTU associated with a SCADA system, which remotely monitors various parameters such as pressure data, temperature data and humidity data associated with weather conditions of a region. For this example, there can be dedicated electronic equipment, such that each of the electronic equipment (or sensors) dedicatedly measures one parameter associated with the weather condition. Further, in this example, each of the electronic equipment can exchange the data with the processing unit 102 of the RTU through a dedicated I/O module. Further, in this example, the processing unit 102 can send the data to a central server of the SCADA system. Further, the processing unit 102 can also process the data prior to sending it. For example, when the processing unit 102 receives data related to the temperature, it can process the data to calculate the rate of heat flow and exchange the processed data with the central server.

The exchange of the data between the processing unit 102 and the I/O module 104 is made through one or more data trains. A data train is a structured bit string containing data and instructions; and is used for communication between the processing unit 102 and the I/O module 104. Further, the processing unit 102 can initiate a data train to send the data to the I/O module 104, similarly, the processing unit 102 can receive the data from the I/O module 104 through a data train initiated by the I/O module 104. The data and instructions are sequenced in the data train as per a data messaging structure. The data messaging structure is a predefined protocol for the exchange of the data between the I/O module 104 and the processing unit 102 and provides for the exchange of one or more data types including an analog input data, an analog output data, a digital input data, a digital output data, a configuration data, a status data and a command data. For example, when the processing unit 102 and the I/O module 104 exchange data through a data train that is 96 bits long, the data messaging structure can be such that the bits from 1 to 64 can contain the data to be exchanged, bits from 65 to 80 can contain instructions for processing the data, bits from 81 to 96 can indicate the schedule for the next data train. Further, specific sets of bits out of the bits 1 to 64 can be assigned to contain different types of data, for example, an analog input data, an analog output data, a digital input data, a digital output data, a configuration data, a status data and a command data.

The data messaging structure can be determined by the I/O module 104 prior to exchanging the data with the processing unit 102. For another embodiment, the data messaging structure can be determined by the processing unit 102 prior to exchanging the data with the I/O module 104.

Further, the processing unit 102 can receive different data points through the at least one I/O modules 104, 106, and 108. When the processing unit 102 is to be operated to receive a new data point (or monitor a new parameter), a corresponding I/O module is added. For example, the electronic control system 100 can be an RTU associated with a SCADA system, which remotely collects data about weather conditions of a region. The processing unit 102 can receive data points regarding temperature and pressure. In order to receive an additional data, for example, humidity, from a new electronic equipment, a new I/O module is added, which operates as an interface between the new electronic equipment and the processing unit 102.

FIG. 2 illustrates an example of an electronic control system 200, in accordance with an embodiment of the present invention. The electronic control system 200 includes a processing unit 102 and at least one I/O module. For the purpose of this description and ease of understanding, the electronic control system is shown to include the I/O module 202, however, it will be readily apparent to those ordinarily skilled in the art that the electronic control system 200 can include more I/O modules as well. Further, the I/O module 202 and the processing unit 102 are functionally coupled and can exchange data with each other. The exchange of the data is primarily governed by the I/O module 202. Further, the processing unit 102 supports the data messaging structure to exchange data with the I/O module 202.

The I/O module 202 includes a processor 204, which governs the exchange of the data between the I/O module 202 and the processing unit 102. In an embodiment, the processor 204 determines the data messaging structure to exchange the data with the processing unit 102. For another embodiment, the processor 204 is also configured to modify the data messaging structure, based on the requirements for exchanging the data. For example, when the I/O module 202 requires exchanging a specific set of instructions with the processing unit 102 in each of a data train, the processor 204 can modify the data messaging structure to include the specific set of instructions. For this embodiment, the processor 204 can also communicate the data messaging structure to the processing unit 102 through a current data train. For example, when the processor 204 modifies the data messaging structure to allow the exchange of a specific set of instructions in each of the subsequent data train, the processor 204 can communicate the modified data messaging structure in the current data train. In an embodiment, the processor 204 can modify the data messaging structure of a subsequent data train and communicate the modified data messaging structure in the current data train. For example, the data messaging structure of each data train can be communicated in a data train previous to it. In an embodiment, the processor 204 can also support the override of a governance of the exchange of the data by the processing unit 102. For example, the processor 204 allows the processing unit 102 to take control of the exchange of data between the I/O module 202 and the processing unit 102 when the I/O module 202 stops functioning properly.

Further, the I/O module 202 includes a transaction module 206 coupled to the processor 204. The transaction module 206 enables the exchange of the data between the I/O module 202 and the processing unit 102 through data trains. For example, once the processor 204 determines the data messaging structure for exchanging the data between the I/O module 202 and the processing unit 102, the transaction module 206 enables transmission of the data train from the I/O module 202 to the processing unit 102. The transaction module 206 also receives data trains from the processing unit 102.

The data trains exchanged between the processing unit 102 and the I/O module 202 include one or more data types, which are supported by the data messaging structure. In an embodiment, the I/O module 202 can also include a translation module 208 to translate the data train into one or more data types such as an analog input data, an analog output data, a digital input data, a digital output data, a configuration data, a status data and a command data. For example, when data regarding the temperature at a particular instant of time is to be exchanged with the processing unit 102, the translation module 208 can translate the data into a digital output data representing the numerical measurement of the temperature and a status data representing the instant of time when the measurement was taken.

In an embodiment, the I/O module 202 can also include a scheduling module 210 to schedule the exchange of the data through at least one data train. The at least one data train can be initiated either by the processing unit or by the I/O module. For example, the scheduling module 210 can determine a sequence of data trains and the time duration between the data trains.

For example, consider that the electronic control system 200 is an RTU associated with a SCADA system, which remotely collects data about weather conditions of a region. For this example, the processing unit 102 can receive data points regarding the temperature from the I/O module 202. The processor 204 determines a data messaging structure to exchange the data regarding the temperature between the I/O module 202 and the processing unit 102. The scheduling module 210 schedules the data trains to exchange the data between the I/O module 202 and the processing unit 102. The translation module 208 translates the data into one or more data types such as an analog input data, an analog output data, a digital input data, a digital output data, a configuration data, a status data and a command data based on the data messaging structure. The translated data is formed into the data train and transmitted to the processing unit through the transaction module 206.

When the exchange of the data is governed by the I/O module 202, the processing unit 102 only needs to recognize the data types provided by the data messaging structure to facilitate the exchange of the data between the I/O module 202 and the processing unit 102. This eliminates the need of additional or modified hardware in the processing unit 102 to enable the exchange of the data between an additional I/O module and the processing unit 102.

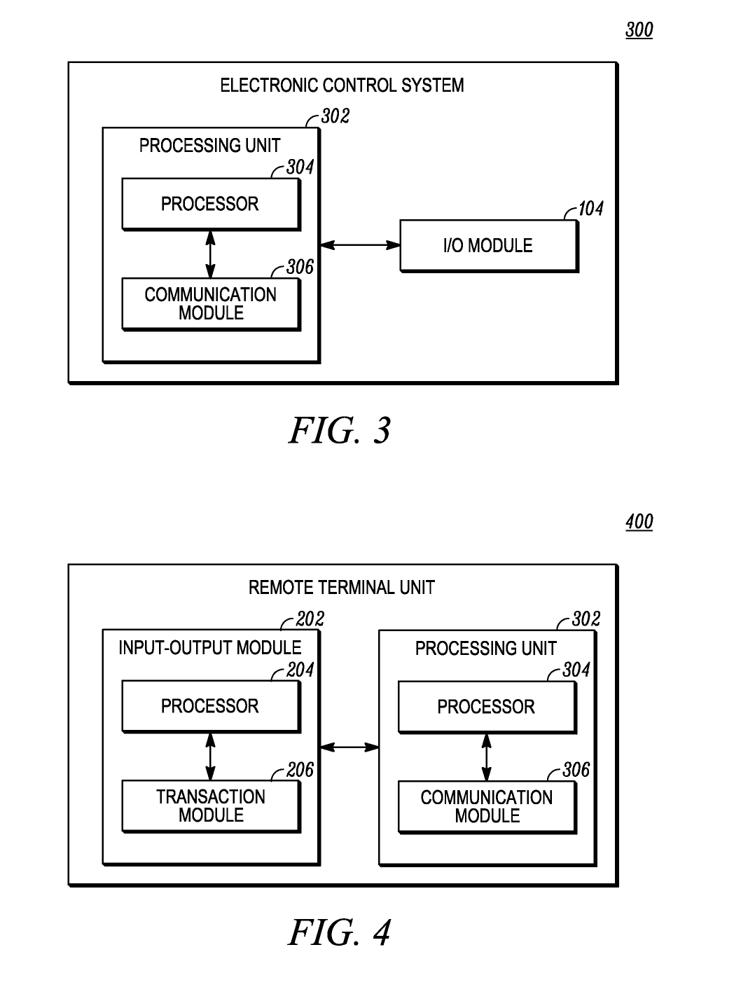

FIG. 3 illustrates an example of an electronic control system 300, in accordance with another embodiment of the present invention. The electronic control system 300 includes at least one I/O module and a processing unit 302. For the purpose of this description and ease of understanding, the electronic control system is shown to include the I/O module 104, however, it will be readily apparent to those ordinarily skilled in the art that the electronic control system 300 can include more I/O modules as well. The I/O module 104 functions similarly as described in conjunction with FIG. 1. The I/O module 104 governs the exchange of data between the processing unit 302 and the I/O module 104. The processing unit 302, which is coupled to the I/O module 104, includes a processor 304 to recognize the I/O module 104, based on the data messaging structure of a data train received from the I/O module 104. For example, when an additional I/O module is added into the electronic control system 300, the processor 304 recognizes the structure to be followed for further communication with the additional I/O module 104, based on the data messaging structure of the data train received from the I/O module 104. The processor 304 exchanges the data with the I/O module 104, based on the recognized data messaging structure.

The processing unit 302 includes a communication module 306 coupled to the processor 304. The communication module 306 supports the exchange of data between the processing unit 302 and the I/O module 104. The communication module 306 can receive the data trains that are initiated by the I/O module 104, based on the schedule determined by the I/O module 104. The communication module 306 can also transmit data trains to the I/O module 104 based on the schedule.

The exchange of the data is primarily governed by the I/O module 104. In an embodiment, the processing unit 302 can override a governance of the exchange of the data by the I/O module 104. In this embodiment, once the processing unit 302 takes control of the governance of the exchange of the data, the processor 304 can reset the I/O module 104. The processing unit 302 can also request the data from the I/O module 104. The processing unit 302 can also schedule the exchange the data through at least one data train. For example, when the processing unit 302 requires the data from the I/O module 104 in a different data messaging structure, the processing unit 302 can override the governance of the exchange of the data between the I/O module 104 and the processing unit 302. The processing unit 302 can reset the I/O module 104 to modify the data messaging structure and the schedule of the data trains. The processing unit 302 can also override the governance to request a specific data from the I/O module 104.

FIG. 4 illustrates an example of an RTU 400 associated with a SCADA system, in accordance with another embodiment of the present invention. The RTU 400 includes at least one I/O module and a processing unit 302. For the purpose of this description and ease of understanding, the RTU 400 is shown to include the I/O module 202, however, it will be readily apparent to those ordinarily skilled in the art that the RTU 400 can include more I/O modules as well. The I/O module 202 functions similarly as described in conjunction with FIG. 2. The processing unit 302 functions similarly as described in conjunction with FIG. 3.

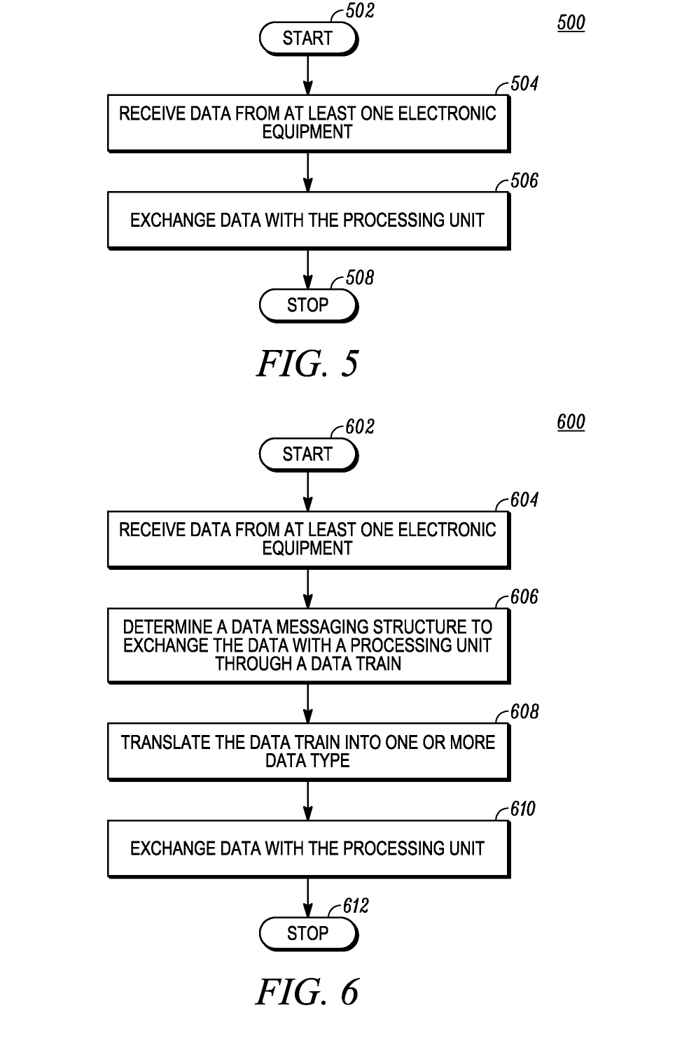

FIG. 5 is a flow diagram 500 illustrating a method for managing exchange of data between at least one input-output (I/O) module and a processing unit, in accordance with an embodiment of the present invention. To describe the flow diagram 500, reference is made to FIG. 4, although it is understood that the flow diagram 500 can be implemented with reference to the FIGS. 1, 2, 3, and any other suitable embodiment of the invention. In addition, the flow diagram 500 can contain a greater or fewer number of steps than those shown in FIG. 5.

At step 502, the method for managing exchange of data between at least one input-output (I/O) module 202 and a processing unit 302 is initiated at the at least one I/O module 202. At step 504, data is received from at least one electronic equipment such as a temperature sensor. The at least one electronic equipment collects one or more data and sends the one or more data to the at least one I/O module 202. The one or more data can be received by the transaction module 206. For example, when the RTU 400 is associated with a SCADA system, which remotely collects data about weather conditions of a region, the at least one electronic equipment collects and sends the data regarding the weather condition, for example, temperature, pressure and humidity, to the at least one I/O module 202. Further, the data regarding the temperature, the pressure and the humidity is received at the at least one I/O module 202. At step 506, the data is exchanged with the processing unit 302. The exchange of the data between the I/O module 202 and the processing unit 302 is governed by the I/O module 202. The data is exchanged by the transaction module 206. The data is exchanged in accordance with a data messaging structure, which allows the exchange of one or more data types including at least one of an analog input data, an analog output data, a digital input data, a digital output data, configuration data, status data and command data. For example, the I/O module 202 exchanges the data regarding the temperature, the pressure and the humidity with the processing unit 302. Thereafter, the method terminates at step 508.

FIG. 6 is a flow diagram 600 illustrating a method for managing the exchange of data between at least one input-output (I/O) module and a processing unit, in accordance with another embodiment of the present invention. To describe the flow diagram 600, reference is made to FIG. 4, although it is understood that the flow diagram 600 can be implemented with reference to the FIGS. 1, 2, 3, and any other suitable embodiment of the invention. In addition, the flow diagram 600 can contain a greater or fewer number of steps than those shown in FIG. 6.

At step 602, the method for managing exchange of data between at least one input-output (I/O) module 202 and a processing unit 302 is initiated at the at least one I/O module 202. At step 604, data is received from at least one electronic equipment such as a pressure sensor. The at least one electronic equipment collects one or more data and sends the one or more data to the at least one I/O module 202. At step 606, a data messaging structure is determined for exchanging data with the processing unit 302. The data messaging structure is determined by the processor 204 to exchange the data through data trains. In an embodiment, the processor 204 modifies an existing data messaging structure prior to exchanging the data with the processing unit 302. For example, when the I/O module 202 requires exchanging a specific set of instructions with the processing unit 302 in each of the subsequent data train, the processor 204 can modify the data messaging structure to include the specific set of instructions. For this embodiment, the modified data messaging structure is communicated to the processing unit 302 through a current data train. The modified data messaging structure is communicated by the transaction module 208.

In an embodiment, the method also includes scheduling the data trains for exchanging the data between the processing unit and the I/O module. The scheduling is done by the scheduling module 210 of the I/O module 202. For example, the scheduling module 210 determines the sequence of the data trains and the time duration between the data trains. In an embodiment, the schedule can be communicated to the processing unit 302 through the data train. The schedule is communicated by the transaction module 206.

In an embodiment, the I/O module supports an override of a governance of the exchange of the data between the processing unit 302 and the I/O module 202 by the processing unit 302. For this embodiment, the processing unit 302 can modify the data messaging structure, schedule the data trains, and reset the I/O module 202. For this embodiment, the some or all of the method steps described to be performed at the I/O module 202 can be performed at the processing unit 302.

In one scenario, when the exchange of the data is governed by the I/O module, at step 608, the data is translated into one or more data types that are supported by the data messaging structure. The one or more data types can be an analog input data, an analog output data, a digital input data, a digital output data, configuration data, status data and command data. The data is translated by the translation module 208. At step 610, the data is exchanged with the processing unit 302. The data is exchanged by the transaction module 206. Thereafter, the method terminates at step 612.

For the purpose of this description, consider an exemplary method for implementing the present invention in a SCADA system. A SCADA system allows control of one or more RTUs located in regions remote to a central SCADA server. The control by central SCADA server can include, but is not limited to, collecting processed data from the RTUs and receiving data about the weather conditions at the location of the RTU. In the exemplary method, consider that an RTU of the SCADA system has three I/O modules. Each I/O module collects data from an electronic equipment (or a sensor) and exchanges it with the processing unit 302 located in the RTU.

When the central SCADA server requires a new type of data from the RTU, a new electronic equipment for collecting the new type of data needs to be provided in the region of the RTU. A new I/O module, for example, the I/O module 202 is also required corresponding to the new electronic equipment. The I/O module 202 exchanges data with the processing unit 302 according to a data messaging structure. For an example, the data messaging structure can be determined by the I/O module 202. For another example, the data messaging structure can be a standard structure that every I/O module uses to exchange the data with the processing unit 302. Through this data messaging structure, the I/O module 202 can also communicate instructions and commands. The I/O module 202 exchanges the data with the processing unit 302 through data trains based on the data messaging structure.

The processor 304 of the processing unit 302 recognizes the structure to communicate with the I/O module 202, based on the data messaging structure of the data train received from the I/O module 202. The processor 304 exchanges the data with the I/O module 202, based on the recognized data messaging structure. The processing unit 302 can override a governance of the exchange of the data between the processing unit 302 and the I/O module 202, based on the requirements of the exchange of the data.

Various embodiments of the method and system for exchanging data between at least one input-output (I/O) module and a processing unit provide several advantages, some of which are discussed herein. Firstly, the processing unit does not require hardware or software modifications to detect an additional I/O module in the system. Consequently, the design cycle time for developing a new I/O module and making corresponding changes in the processing unit is reduced. Further, since the changes in the hardware are not required, a new I/O module can be added into the system at a comparatively lower price. Secondly, the I/O module can also govern the exchange of the data between the I/O module and the processing unit.

In the foregoing specification, the invention and its benefits and advantages have been described with reference to specific embodiments. However, one of ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. An electronic control system comprising:
a processing unit for supporting a data messaging structure to exchange data in the electronic control system; and
at least one input-output (I/O) module coupled to the processing unit and comprising:
a processor for governing the exchange of the data between the at least one I/O module and the processing unit, the data being exchanged in the data messaging structure, wherein the data messaging structure provides for the exchange of one or more data type, the one or more data type comprising at least one of an analog input data, an analog output data, a digital input data, a digital output data, a configuration data, a status data and a command data; and
a transaction module coupled to the processor for enabling the exchange of the data between the at least one I/O module and the processing unit through a data train.

2. The electronic control system as claimed in claim 1, wherein the processor further determines the data messaging structure for exchanging the data with the processing unit.

3. The electronic control system as claimed in claim 1, wherein the at least one I/O module comprises a translation module for translating the data train into one or more data type, the one or more data type comprising at least one of an analog input data, an analog output data, a digital input data, a digital output data, a configuration data, a status data and a command data.

4. The electronic control system as claimed in claim 1, wherein the at least one I/O module comprises a scheduling module for scheduling the exchange of the data through at least one data train, wherein the at least one data train is initiated by at least one of the processing unit and the at least one I/O module.

5. The electronic control system as claimed in claim 1, wherein the processor further supports override of a governance of the exchange of the data by the processing unit.

6. The electronic control system as claimed in claim 1, wherein the processor is further configured to at least one of:
modify the data messaging structure for subsequent data train; and
communicate the data messaging structure to the processing unit through the data train.

7. The electronic control system as claimed in claim 1, wherein the electronic control system is a remote terminal unit (RTU) of a supervisory control and data acquisition (SCADA) system.

8. An electronic control system comprising:
at least one input-output (I/O) module for governing an exchange of data in the electronic control system; and
a processing unit coupled to the at least one input-output module and comprising:
a processor for recognizing the at least one I/O module based on a data messaging structure of a data train received from the at least one I/O module, wherein the data messaging structure allows the exchange of one or more data type, the one or more data type comprising at least one of an analog input data, an analog output data, a digital input data, a digital output data, configuration data, status data and command data; and
a communication module coupled to the processor for supporting the exchange of the data between the processing unit and the at least one I/O module.

9. The electronic control system as claimed in claim 8, wherein the communication module further receives at least one data train based on a schedule, wherein the schedule is determined by the at least one I/O module, wherein the at least one data train is initiated by at least one of the processing unit and the at least one I/O module.

10. The electronic control system as claimed in claim 8, wherein the processing unit further overrides a governance of the exchange of the data, the exchange of the data being previously governed by the at least one I/O module.

11. The electronic control system as claimed in claim 10, wherein the processor is further configured to at least one of:
resetting the at least one I/O module;
requesting the data from the at least one I/O module; and
scheduling the exchange of the data through at least one data train.

12. The electronic control system as claimed in claim 8, wherein the electronic control system is a remote terminal unit (RTU) of a supervisory control and data acquisition (SCADA) system.

13. A method for managing exchange of data between at least one input-output (I/O) module and a processing unit, the method at the at least one I/O module comprising:
receiving the data from at least one electronic equipment, wherein the at least one electronic equipment collects one or more data; and
exchanging the data with the processing unit, wherein the exchange of data is governed by the at least one I/O module, the data being exchanged in a data messaging structure, wherein the data messaging structure allows exchange of one or more data type, the one or more data type comprising at least one of an analog input data, an analog output data, a digital input data, a digital output data, configuration data, status data and command data.

14. The method as claimed in claim 13 further comprising:
determining the data messaging structure to exchange the data with the processing unit.

15. The method as claimed in claim 13 further comprising:
modifying the data messaging structure for a subsequent data train; and
communicating the data messaging structure to the processing unit through a current data train.

16. The method as claimed in claim 13 further comprising:
scheduling the exchange of the data through at least one data train, wherein the at least one data train is initiated by at least one of the processing unit and the at least one I/O module.

17. The method as claimed in claim 13 further comprising:
translating the data train into one or more data type, the one or more data type comprising at least one of an analog input data, an analog output data, a digital input data, a digital output data, a configuration data, a status data and a command data.

18. The method as claimed in claim 13 further comprising:
supporting override of governance of the exchange of the data by the processing unit.
